(19) United States
(12) Patent Application Publication
(10) Pub. No.: US 2003/0046322 A1
(43) Pub. Date: Mar. 6, 2003

(54) Flowgraph representation of discrete wavelet transforms and wavelet packets for their efficient parallel implementation

(76) Inventor: David Guevorkian, Tampere (FI)

Correspondence Address: PERMAN & GREEN, 425 POST ROAD, FAIRFIELD, CT, 06824, US

(21) Appl. No.: 10/155,944

(22) Filed: May 24, 2002

Related U.S. Application Data
(60) Provisional application No. 60/295,292, filed on Jun. 1, 2001.

(51) Int. Cl. G06F 17/14

(52) U.S. Cl. 708/400

(57) ABSTRACT

The invention relates to a microprocessor structure for performing a discrete wavelet transform operation. It uses a flowgraph representation of discrete wavelet transforms (DWTs) and wavelet packets. This representation is useful for developing efficient parallel algorithms and VLSI architectures. As examples, two DWT architectures for Haar wavelets and three architectures for Hadamard wavelets and wavelet packets are proposed with the efficiency (counted as the measure of the average utilization of basic processing elements) of approximately 100%. The proposed architectures are fast and provide excellent performance with respect to area-time characteristics. They are scalable, simple, regular, and free of long connections (depending on the length of input signal). The invention can be extended to inverse wavelet transforms.

The invention relates to a microprocessor structure for performing a discrete wavelet transform operation.

### 1. INTRODUCTION

Discrete wavelet transforms (DWTs) are relatively new tools for presenting signals in a decomposed form where the signal is presented in different levels of detalization in the time and frequency domain. During the last decade, DWTs have been intensively studied and successfully applied to a wide range of applications such as numerical analysis, biomedicine, different branches of image and video processing, signal processing techniques, speech compression/decompression, etc [1]-[4]. DWTs have often been found preferable to other traditional transform techniques due to such useful features as inherent scalability, linear computational complexity, low aliasing distortion for signal processing applications, and adaptive time-frequency windows. DWTs have become basis of international image/video coding standards JPEG 2000 and MPEG-4.

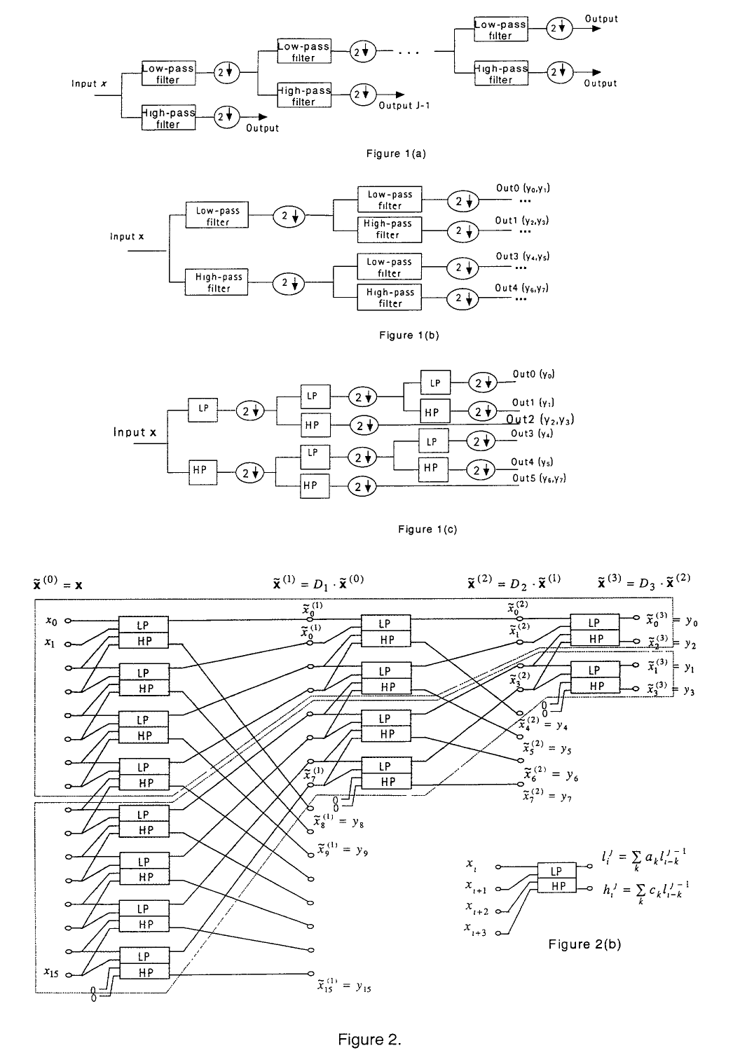

Since most of the applications require real-time implementation of DWTs, the design of fast parallel VLSI ASIC's for DWTs has recently captivated the attention of a number of researchers. Many architectures have already been proposed for implementing the classical (or Haar) DWT [5]-[17] while much less attention has been paid to architectures for Hadamard wavelets and wavelet packets. Some of these devices have been targeted to have a low hardware complexity but they require at least 2N clock cycles (cc's) to compute the Haar DWT of a sequence of length N (see e.g. [1]-[3]). Nevertheless, also a large number of Haar DWT architectures, having a period of approximately N cc's, have been designed [7]-[12]. Most of these architectures exploit the Recursive Pyramid Algorithm (RPA) [15] based on the tree-structured filter bank representation of DWTs shown in FIG. 1. In this representation the input signal is processed by several levels of decomposition where the length of the processed signal is twice reduced from level to level in the case of Haar wavelets. Even though pipelining has been employed to implement this structure, known pipelined architectures for Haar DWTs use the same number of processing elements for every pipeline stage. Balancing of the pipeline stages is achieved by making the clocking frequency twice smaller from a stage to stage (see e.g. [13], [14]). As a consequence of such under-utilization of processing elements, the typical efficiency parameter for known architectures is estimated to be much less than 100%. Highly efficient architectures (about 100%) for Haar wavelets have been developed in [16], [17] by including approximately twice lower number of processing elements from stage to stage.

According to the invention there is provided a new approach for implementation of DWTs (Haar wavelets, Hadamard wavelets as well as wavelet packets). The approach is based on representation of DWTs using flowgraphs similar to those known for traditional fast transforms; like the fast Fourier, Walsh, Haar and other transforms (see [18]).

Embodiments of the invention will now be described by way of example only with reference to the accompanying drawings in which:

FIG. 1 shows Tree structure filter bank representation of DWTS: (a) Haar wavelets; (b) Hadamard wavelets; (c) a wavelet packet example;

FIG. 2 shows an example of the flowgraph representation of a 1-D Haar DWT (N=16, L=4, J=3);

FIG. 2(b) shows a basic DWT operation;

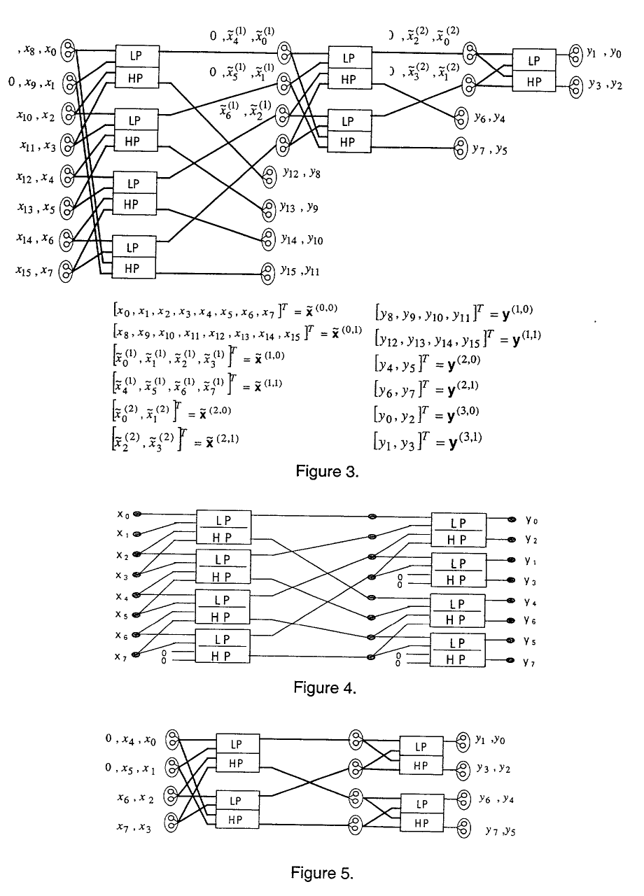

FIG. 3 shows a compact flowgraph representation of a 1-D Haar wavelet (L=4, J=3);

FIG. 4 shows an example of the flowgraph representation of Hadamard wavelets;

FIG. 5 shows a compact flowgraph representation of a 1-D Hadamard wavelet (L=4, J=3).;

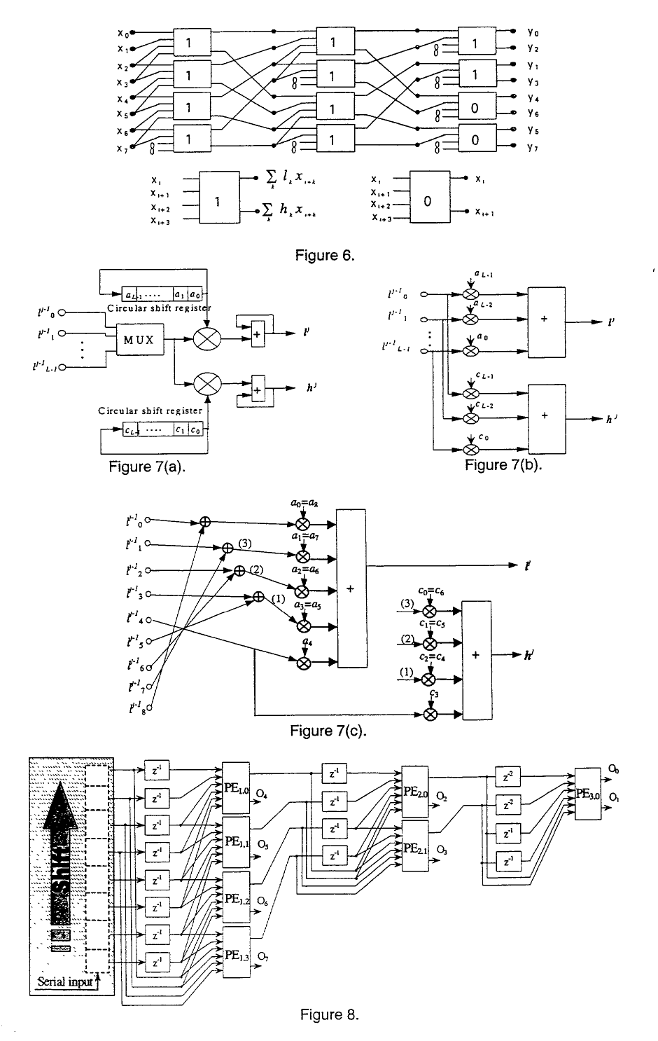

FIG. 6 shows a flowgraph representation of the wavelet packet in FIG. 1(c);

FIG. 7 shows possible structures for PEs in FPP or LPP architectures: (a) MAC unit based structure; (b) Tree of adders based structure; (c) A specialized PE structure for Daubechies 9-7 DWT;

FIG. 8 shows the LPP architecture (L=6, J=3) in which a serial/parallel adapter is used in the case of word-serial input;

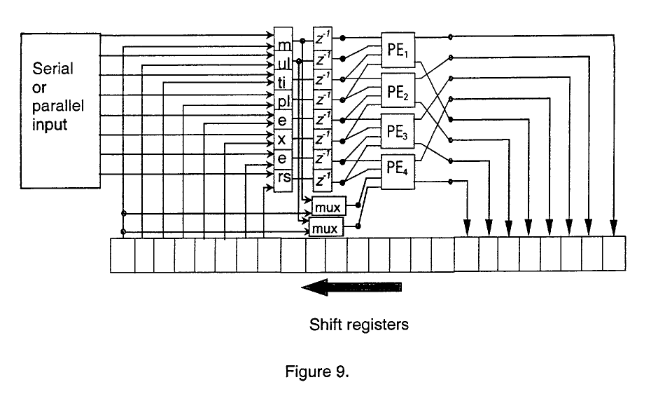

FIG. 9 shows an example of the LP architecture for Hadamad wavelets and wavelet packets (N=32, L=4).

The fLowgraph representation of DWTs will now be described. Advantages of the new representation are then discussed from the architecture design point of view. As examples of such designs we present several architectures (called FPP DWT, LPP DWT and LP DWT). The efficiency of both architectures is approximately 100%. They are very fast and provide excellent performance with respect to area-time characteristics. They are scalable, simple, regular, and free of long connections (depending on the length of input signal).

### 2.THE FLOWGRAPH REPRESENTATION OF DWTs

Several alternative definitions/representations of DWTs such as tree-structured filter bank [3], lattice structure [21]-[23], lifting scheme [24], [25] or matrix representation have been introduced during the last decade. Each of this representations has advantages from a certain point of view. These definitions/representations have been primarily targeted to easy synthesis and analysis of wavelets, and to their simple implementation as a secondary aim only. However, DWT architectures proposed in the literature so far are based on one of these representations. The invention concerns a flowgraph representation of wavelets primarily targeted to designing parallel algorithms and architectures for implementation of wavelets. The new representation is similar to those widely used for representation of fast traditional transforms such as fast Haar, Fourier, of Hadamard transforms.

Most of the existing DWT architectures (e.g. those in [6], [13], [14], [27]) are based on the tree-structured filter bank representation of DWTs shown in FIG. 1 where several (J) levels of signal decomposition are applied. Every decomposition level (also called an octave) constitutes low-pass and high-pass filtering followed by a factor of two downsampling of the results of both bands. The input signal x=[x₀, . . . , x_{N-1}]^{T} is of the length N=2^{m} and is assumed to be appended with L−2 points, where L is the length of the low-pass and high-pass filters. For clarity of presentation, we assume that both the low-pass and the high-pass filters are of the same length which is an even number. However, it should be clear that the invention can readily be applied to arbitrary filter lengths. Several strategies for choosing the values of appended points exist (e.g. symmetric or antysimmetric extension, zero-padding, etc.). Here we assume that L−2 zeros are appended to the end of the signal at every octave. However, other appending strategies can be used.

The Haar wavelets, the Hadamard wavelets and the wavelet packets differ in that whether the results of both the low-pass and high-pass filtering or the results of only the low-pass filtering of a given octave are further processed in the next octave. Each of these cases is considered separately in the following.

### 2.1.The Flowgraph Representation of Haar Wavelets

In the case of the Haar wavelets shown in FIG. 1 (a), only the results of the low-pass filtering of a given octave are processed with the next octave. The input to the j-th octave, j=2, . . . , J, is of length 2^{m-j+1}+L−2 where the first 2^{m-j+1} samples are the low-pass outputs of the (j−1)-st octave (after downsampling) and the last L−2 samples are appended points (zeros in our above assumption).

One can see a computational redundancy in the tree-structure representation of DWTs (as for Haar wavelets as well as for Hadamard wavelets and wavelet packets). This redundancy is related to downsampling which is, however, not inherent to the DWT computation (naturally a sophisticated computational scheme would not directly implement downsampling but rather would not compute every second output of low-pass and high-pass filters).

Another obvious problem with the tree-structure representation of Haar wavelets is that the input signal (without the appended points) is twice shorter from an octave to the next octave. This creates difficulties in developing pipelined designs. In a straightforward pipelining where the octaves are mapped into similar pipeline stages, the hardware underutilizaton would occur since every next stage would have twice less computations to implement compared to the previous one. Some designs (see e.g. [10], [17]) overcome this difficulty by implementing the first octave in one pipeline stage and all the others in the second stage. However, interleaving several octaves in one leads to complicated control and data routing schemes or extensive memory requirements as well as to a restricted pipelining where only two stages are used.

Let us also note that the tree structure representation (as for Haar wavelets as well as for Hadamard wavelets and wavelet packets) assumes digit-serial input signals and it hides the parallelism of octaves which is, however, inherent to DWT computation as we will see later from the flowgraph representation. Similar problems are typical also for lattice structure and lifting scheme representations of DWTs.

Another widespread definition/representation of DWTs is based on the matrix approach. The schemes in FIG. 1 is equivalent to the discrete linear transform

y=H·x, (1)

where X=[x₀, . . . , x_{N-1}]^{T} and y=[y₀, . . . , y_{N-1}]^{T} are, respectively, the input and the output vectors of length N=2^{m} and H is the DWT matrix of order N×N which is formed as the product of sparse matrices:

H=H^{(J)}H^{(J-1)}·. . . ·H⁽¹⁾, 1≦J≦m; (2)

In the case of the Haar wavelets (see FIG. 1(a)), matrices H^{(j)} are of the form

$${H}^{( j )} = ( \begin{matrix}{D}_{j} & 0 \\ 0 & {I}_{{2}^{m} - {2}^{m - j + 1}}\end{matrix} ) , j = 1 , … , m \qquad ( 3 )$$

where Dⱼ is the analysis (2^{m-j+1}×2^{m-j+1}) matrix at stage j, and Iₖ is the identity (k×k) matrix (k=2^{m}−2^{m-j+1}). If the vector of coefficients of the low-pass and of the high-pass filters in the scheme of FIG. 1(a) are respectively denoted as LP=[l₁, . . . ,l_{L}] and HP=[h₁, . . . ,h_{L}] (L being the length of the filters) then the matrix Dⱼ is of the form:

$${D}_{j} = ( \begin{matrix}{l}_{1} & {l}_{2} & … & {l}_{L} & 0 & 0 & … & 0 \\ 0 & 0 & {l}_{1} & {l}_{2} & … & {l}_{L} & … & 0 \\ & & & ⋰ & & & & \\ 0 & 0 & … & & & … & {l}_{1} & {l}_{2} \\ {h}_{1} & {h}_{2} & … & {h}_{L} & 0 & 0 & … & 0 \\ 0 & 0 & {h}_{1} & {h}_{2} & … & {h}_{L} & … & 0 \\ & & & ⋰ & & & & \\ 0 & 0 & … & & & … & {h}_{1} & {h}_{2}\end{matrix} ) = {P}_{j} \cdot ( \begin{matrix}{l}_{1} & {l}_{2} & … & {l}_{L} & 0 & 0 & … & 0 \\ {h}_{1} & {h}_{2} & … & {h}_{L} & 0 & 0 & … & 0 \\ 0 & 0 & {l}_{1} & {l}_{2} & … & {l}_{L} & … & 0 \\ 0 & 0 & {h}_{1} & {h}_{2} & … & {h}_{L} & … & 0 \\ & & & ⋰ & & & & \\ & & & & & & & \\ 0 & 0 & … & & & … & {l}_{1} & {l}_{2} \\ 0 & 0 & … & & & … & {h}_{1} & {h}_{2}\end{matrix} ) \qquad ( 4 )$$

where Pⱼ is the matrix of the perfect unshuffle operator (see [18]) of the size (2^{m-j+1}×2^{m-j+1}).

Adopting the representation (1)-(4), the DWT is computed in J stages (J being the number of octaves):

x⁽⁰⁾=x; x^{(j)}=H^{(j)}·x^{(j-1)}, j=1, . . . , J, y=x^{(j)}, (5)

where x^{(j)}, j=1, . . . , J, is an (N×1) vector of scratch variables. Noting that lower right corner of every matrix H^{(j)} is an identity matrix, the algorithm of (5) can be rewritten as:

\tilde{x}⁽⁰⁾=x; \tilde{x}^{(j)}=D_{J}·\tilde{x}^{(j-1)}(0:2^{m-j+1}−1), j=1, . . . ,J, y=[\tilde{x}^{(J)}, \tilde{x}^{(J-1)}(2^{m-J+1}:2^{m-J+2}), . . . ,\tilde{x}⁽²⁾(2^{m-2}:2^{m-1}−1), \tilde{x}⁽¹⁾(2^{m-1}:2^{m}−1)]^{T}, (6)

where \tilde{x}^{(J)}=[\tilde{x}₀^{J}, . . . ,\tilde{x}₂_{^{m-J+1}}₋₁^{J}]^{T}, J=1, . . . ,J, is a (2^{m-j+1}×1) vector of scratch variables, and x(a:b) denotes the subvector of x consisting of the a-th to b-th components of x.

Computation of (6) with the matrices H^{(j)} of (3), (4) can be clearly demonstrated using a flowgraph representation. An example for the case N=2⁴=16,L=4,J=3 is shown in FIG. 2. The flowgraph consists of J stages, the j-th stage, j=1, . . . ,J, having 2^{m-j} nodes (depicted as boxes in FIG. 2). Each node represents a basic DWT operation (see FIG. 2(b)). The i th node, i=0, . . . ,2^{m-J}−1, of the stage j=1, . . . , J has incoming edges from L consecutive nodes 2i, 2i+1, . . . ,2i+L−1 of the preceding stage or (for the nodes of the first stage) from inputs. Every node has two outgoing edges. An upper (lower) outgoing edge represents the value of the inner product of the vector of low-pass (high-pass) filter coefficients with the vector of the values of incoming edges. Outgoing values of a stage are permuted according to the perfect unshuffle operator so that all the low-pass components (the values of upper outgoing edges) are collected in the first half and the high-pass components are collected at the second half. Low pass components are then forming the input to the following stage or (for the nodes of the last stage) represent output values. High-pass components represent output values at a given resolution.

The flowgraph representation of Haar wavelets as it has yet been presented has an inconvenience of being very large for bigger values of N. This inconvenience can be overcome based on the following observation. Assuming J<log₂N (in the most of applications J<<log₂N) one can see that the flowgraph of a Haar wavelet consists of N/2^{J} similar patterns (see the two hatching regions in FIG. 2). Every pattern can be considered as a 2^{J}-point DWT with a specific strategy of forming the input signals to its every octave. Let us conventionally divide the 2^{m-j+1} input values of the j-th, j=1, . . . ,J, octave within the original DWT (of length N=2^{m}) into N/2^{J}=2^{m-J} non-overlapping groups consisting of 2^{J-j+1} values. This is equivalent to dividing the vector \tilde{x}^{(j-1)}(0:2^{m-j+1)} in the algorithm of (4) into subvectors \tilde{x}^{(j-1,s)}=\tilde{x}^{(j-j+1)}(s·2^{J-j+1}:(s+1)·2^{J-j+1}−1), s=0, . . . ,2^{m-J}−1. Then the input of the j-th, j=1, . . . ,J, octave within the s-th pattern is the subvector \tilde{x}^{(j-1,s)} appended with the first L−2 samples from the next subvectors \tilde{x}^{(j-1,s+1)}, \tilde{x}^{(j-1,s+2)}, . . . , \tilde{x}^{(j-1,2}_{^{m-J}}₋₁₎ or zeros (if there are no L−2 samples within these subvectors).

Merging the 2^{m-J} patterns in one, we can now obtain compact (or core) flowgraph representation of DWT. An example of a DWT compact flowgraph representation for the case J=3, L=4 is shown in FIG. 3. The compact flowgraph of a Haar wavelet has 2^{J-j} nodes at its j-th, stage, j=1, . . . ,J, where now a set of 2^{m-J} values are assigned to every node. Thus every node represents a time-varying scratch variable or, in other words, the scratch variables of the algorithm (6) are distributed over the nodes of the compact DWT flowgraph not only spatially, but also temporally. Every node has L incoming and two outgoing edges like in the (“incompact”) DWT flowgraph. Again incoming edges are from L “consecutive” nodes of the previous stage but now with a convention that nodes are counted in a circular manner by modulo 2^{J-j} for the j-th, stage, j=1, . . . ,J.

Also, outputs are now distributed over the outgoing edges of the compact fLowgraph not only spatially but also temporally. That is, every outgoing edge corresponding to a high-pass filtering result of a node or low-pass filtering result of the node of the last stage represents a set of 2^{m-J} output values.

Note that the structure of the compact flowgraph does not depend on the length of the DWT but only on the number of decomposition levels and filter length. The DWT length is reflected only in the number of values represented by every node. Also note that the compact flowgraph has the structure of 2^{J}-point DWT with slightly modified appending strategy.

### 2.2.The Flowgraph Representation of Hadamard Wavelets

In the case of the Hadamard wavelets in FIG. 1b, not only the results of the low-pass filtering but also the results of the high-pass filtering of every octave are processed with the next octave. Thus, the j-th octave j=1, . . . ,J, process 2^{j-1} signals each of the length 2^{m-j+1}. Every of these signals is appended with L+2 zeros and then low-pass and high-pass filtered. Every resulting signal is downsampled by a factor of two and then enters to the next octave. Similarly as in the case of Haar wavelets, there is a redundancy in the flowgraph definition of Hadamard wavelets and the parallelism of stages is hidden. However, in contrast to the Haar wavelet case, the input to every next octave is not shorter but rather longer (due to appended points) compared to the input to the previouse octave.

Similarly to the Haar wavelets, the Hadamard wavelets are also presented in the matrix representation of (1)-(2) where now matrices H^{(J)} are of the form of the matrices Dⱼ (see (4)) but of the size (2^{m-1}×2^{m-1}). Thus, the fast algorithm of (5) is directly applicable for computation of Hadamard wavelets.

The flowgraph representation of the algorithm (5) can similarly be considered as it was described in the case of the Haar wavelets. An example for the case N=2³=8,L=4,J2 is shown in FIG. 4. The flowgraph consists of J stages, the j-th stage, j=1, . . . ,J, having 2^{m-1} nodes (depicted as boxes on FIG. 2). Each node represents a basic DWT operation (see FIG. 2(b)). The ith node, i=0, . . . ,2^{m-1}, of the stage j=1, . . . ,J has incoming edges from L consecutive nodes 2i, 2i+1, . . . ,2i+,L−1 of the preceding stage or (for the nodes of the first stage) from inputs. Every node has two outgoing edges. An upper (lower) outgoing edge represents the value of the inner product of the vector of low-pass (high-pass) filter coefficients with the vector of the values of incoming edges. Outgoing values of a stage are permuted according to the perfect unshuffle operator so that all the low-pass components (the values of upper outgoing edges) are collected in the first half and the high-pass components are collected at the second half. All the components (both the low-pass and the high-pass) are then forming the input to the following stage or (for the nodes of the last stage) represent output values.

The main difference between Haar wavelet flowgraphs and Hadamard wavelet flowgraphs is that the former ones are of a “semitriangular” form while the latter ones are of “semirectangular form.” This means that a reducing from an octave to octave parallelism level is inherent to Haar DWTs while a uniform parallelism level of octaves is inherent to Hadamard DWTs. An “arbitrary reducing” from an octave to octave level of parallelism is inherent to wavelet packets.

Assuming J<log₂N one can see that the flowgraph of a Hadamard wavelet consists of N/2^{J} similar patterns (see the two hatching regions on FIG. 2). Every pattern can be considered as a 2^{J}-point DWT with a specific strategy of forming the input signals to its every octave. Let us conventionally divide the 2^{m-1} input values of the j-th, j=1, . . . ,J, octave within the original DWT (of length N=2^{m}) into N/2^{J}=2^{m-J} non-overlapping groups consisting of 2^{j-1} values. This is equivalent to dividing the vector X^{(j-1)} in the algorithm of (5) into subvectors x^{(j-1,s)}=x^{(j-1)}(s·2^{J-1}:(s+1)·2^{J-1}−1), s=0, . . . ,2^{m-J}−1. Then the input of the j-th, j=1, . . . ,J, octave within the s-th pattern is the subvector x^{(j-1,s)} appended with the first L−2 samples from the next subvectors x^{(j-1,s+1)}, x^{(j-1,s+2)}, . . . , x^{(j-1,2}_{^{m-J}}₋₁₎ or zeros (if there are no L−2 samples within these subvectors).

Merging the 2^{m-J} patterns in one, we can now obtain compact (or core) flowgraph representation of Hadamard wavelets. . An example of a compact flowgraph representation for a Hadamard wavelet corresponding to the case J=2, L=4 is shown on FIG. 5. The compact flowgraph has 2^{J-1} nodes at its j-th, stage, j=1, . . . ,J, where now a set of 2^{m-J} values are assigned to every node. Every node has L incoming and two outgoing edges like in the (“incompact”) flowgraph. Again incoming edges are from L “consecutive” nodes of the previous stage but now with a convention that nodes are counted in a circular manner by modulo 2^{J-1}. Also, outputs are now distributed over the outgoing edges of the compact flowgraph not only spatially but also temporally. That is, every outgoing edge represents a set of 2^{m-J} output values.

### 2.3.The Flowgraph Representation of Wavelet Packets

Wavelet packets take an intermediate place between Haar wavelets and Hadamard wavelets in the sense of forming inputs to octaves. Some of the output signals of every octave are further processed with next octaves and some of them form the outputs of the transform (see FIG. 1(c)). The signals that will be further processed are chosen according to one or another optimization strategy depending on applications. From an implementational point of view this means that arbitrary tree structure should be supported. In particular, wavelet packet may become a full Hadamard wavelet. Thus, we can consider the flowgraph representation of wavelet packets by slightly modifying the flowgraph representation of Hadamard wavelets so that its nodes may denote two types of operations: the basic DWT operation (see FIG. 2), and NOP operation (first two inputs are passing to outputs without changing). An example of a flowgraph representing the wavelet packet transform of FIG. 1(c) is shown in FIG. 6 where the nodes representing the basic DWT operation are denoted with unity and the nodes representing NOP operation are denoted with zeros.

Compact flowgraph representation of wavelet packet transforms similar to the compact flowgraph representation of Hadamard transforms may also be considered where a sequence of ones and zeros must be associated with every node to make some nodes representing NOP operations at some time instants.

### 2.4.Advantages of the Flowgraph Representation of DWTs

Essentially, the flowgraph representation gives an alternative, rather demonstrative and easy-to-understand definition of discrete wavelet transforms. It has several advantages, at least from implementational point of view, as compared to the conventional DWT representations such as tree-structured filter bank, lifting scheme or lattice structure representation. Some of these advantages are as follows.

There is no computational redundancy in the flowgraph representation of DWTs neither due to downsampling (existing in the conventional representations) nor otherwise.

The flowgraph representation reveals the parallelism of every octave, which is inherent in the DWTs but is hidden in their conventional representations.

Like in the conventional representations, the input to every octave is still twice shorter from stage to stage but, since parallelism of stages is now revealed, a simple idea of using twice less hardware for implementation of every next stage may overcome the problem of hardware underutilization without employing a complicated control or data routing schemes between stages.

The input to every octave is presented as a whole making it possible to process both digit-serial and digit-parallel input signals in flowgraph representations, whereas tree-structure filter bank or lifting scheme representations support essentially digit-serial signals (the lattice structure based approaches could support also digit-parallel inputs but typically they do not).

The flowgraph representation is, in fact a direct generalization of the traditional (block) fast transform flowgraph representations (see e.g. [18],[28]) corresponding to the case L=2 which makes it possible to extend the well studied approaches for implementation of traditional transforms to DWTs.

In the next section several architectures which are designed with an approach based on the flowgraph representation of DWTs are described. Other, perhaps, even more sophisticated architectures could be designed using the flowgraph approach. However, the most illustrative architectures are described in order to better explore the approach to designing DWT architectures based on their flowgraph representation.

### 3. HIGHLY EFFICIENT SCALABLE DWT ARCHITECTURES

The DWT flowgraphs described in the previous section are very regular and provide a systematic approach to design different parallel DWT algorithms and architectures similar to as the well-known fast transform flowgraphs provide for the traditional transforms [18]. Below are presented some examples of DWT architectures designed by analyzing the corresponding flowgraphs. In fact, these architectures can be considered as extensions of the parallel-pipelined designs proposed in [28], [31] (see also [18]) for families of Haar-like and Fourier-like transforms.

It should be noted that the presented architectures just tend to demonstrate the power of the flowgraph analysis based approach to developing efficient parallel/pipelined DWT architectures. So, the architectures are only presented in a general form to demonstrate principles and some architectural details (such as PE structure, interconnections, etc.) which would be present in a complete design of a sophisticated DWT architecture are omitted for the purposes of clarity.

### 3.1. Fully Parallel-Pipelined (FPP) Architectures for DWTs

These architectures, which we call fully parallel-pipelined or FPP DWT architectures, are obtained by a direct “one-to-one” mapping of the corresponding (Haar or Hadamard) DWT flowgraph to a processor architecture where the nodes of the flowgraph represent processor elements (PEs) and edges represent interconnections. Different structures of PEs implementing the basic DWT operation can be developed. Any PE that is capable of implementing a pair of inner products of the vector on its inputs with a pair of predefined vectors of coefficients can be employed. A simple example of a PE has a pair of multiply-accumulate (MAC) units as used in digital signal processors and shown in FIG. 7(a). Another example is the PE consisting of two columns of multipliers and two trees of adders as shown in FIG. 7(b) where pipelined multipliers and adders can be used. It should be noted that these are just examples of “generic” PEs, which are programmable to any filter coefficients. Clearly, PEs can be further simplified by making use of dependencies between low-pass and high-pass filter coefficients of a specific wavelet transform. For example, due to the symmetries in the Deabuchies 9-7 filters one can use PE of the structure shown in FIG. 7(c) for the corresponding transform [30].

To support a wavelet packet transform implementation, the PEs should be also able to operate in two modes: the first mode for implementing the basic DWT operation as discussed above and the second mode for implementing NOP operations. This may simply be achieved by multiplexing the first two inputs of every PE with its outputs.

The input to the FPP can be made as word-parallel (consider small circles at the first stage on FIG. 2(a), FIG. 4, or FIG. 6 as input ports) as well as word-serial by adding a shift register at the input and making use of buffering as shown in FIG. 8.

The architecture can be efficiently pipelined by considering small circles at intermediate stages (see FIG. 2 or FIG. 4) as latches and the group of PEs corresponding to nodes of one octave as a pipeline stage. In the pipelined mode, we assume that the architecture computes DWTs of a stream of M vector-signals (of length N) which is often the case (consider, for instance, a separable 2-D DWT). Then DWTs of J vector-signals are being computed simultaneously at every time instant The input vectors enter to the architecture at the rate of one vector-signal per one time unit, At the same rate, but with the delay of J time units, the output vectors are formed. Here the duration τ of the time unit is equal to the period of one DWT operation and depends on the used PE structure. If, for instance, a pair of MAC units (FIG. 7(a)) is used, then the time unit is equal to L times the period of one multiplication. In the case of PEs in FIG. 7(b), the time unit is equal to the period of one multiplication.

It is easy to see that, in the pipelined mode, for big values of M (M>>J,) approximately 100% hardware utilization of the FPP architecture is achieved regardless which kind of PEs are used. Indeed, to process all the M vector-signals M+J−1 time units are needed during which every PE operates M time units. More formally, let us define the measure of hardware utilization (or efficiency) for a parallel/pipelined architecture as:

$$E = \frac{T ( 1 )}{K \cdot T ( K )} \cdot 100 \% , \qquad ( 7 )$$

where T(1) is the time of implementation of an algorithm with one PE and T(K) is the time of implementation of the same algorithm with the architecture consisting of K PEs. In the case of the Haar DWT T(1)=M(2^{m}−1)τ, K=(2^{m}−1), and in the case of the Hadamard DWT T(1)=MJ2^{m-1}τ, K=J2^{m-1}. In the both cases, T(K)=(M+J−1)τ. Substituting these values into (7), we obtain

$${E}_{F P P - p} = \frac{M}{M + J - 1} \cdot 100 \%$$

as an estimate for the efficiency of the FPP architecture in the pipelined mode. Clearly, E_{FPP-p}≈100% if the number M of the processed vector-signals is sufficiently high.

The efficiency of the FPP in the non-pipelined mode is estimated as E_{FPP-np}=(100/J) which is rather pure. Nevertheless, even in this case the architecture is very fast. Its delay is estimated as T_{FPP-np}=J time units while the known Haar DWT architectures require at least O(N) time units.

Table 1 summarizes Area-Time characteristics of the Haar DWT FPP architecture (both in pipelined and non-pipelined modes) assuming PEs of FIG. 7(b) in comparison with some known Haar DWT architectures. These characteristics have been obtained under an assumption that the area unit is the one occupied by one adder and one multiplier, and the time unit is (as above) the time for one multiplication and one addition. The same assumption is normally done for performance evaluation of DWT architectures by other authors. Note that the architecture provides very high performance with respect to the ATₚ² parameter. It also should be noted that the architecture is very regular and needs an easy control (which is, essentially, a clock only) unlike, e.g. the architecture of [10]. It does not contain a feedback, a switch, or long connections depending on the size of the input but only connections of the maximum of O(L) length. Thus, it can be implemented as a semisystolic array.

TABLE 1
Comparative performance of some DWT architectures

| Architecture | Area, A | Period, Tₚ | ATₚ² |
|---|---|---|---|
| FPP DWT | 2NL(1 − 1/2^{J}) | J┌log₂ L┐ | 2NLJ²┌log₂ L┐² (1 − 1/1/2^{J}) |
| (non- | | | |
| pipelined) | | | |
| FPP DWT | 2NL(1 − 1/2^{J}) | 1 (per | 2NL(1 − 1/2^{J}) |
| (pipelined) | | vector) | |
| LPP DWT | (2^{J} − 1)(2L − 1) | ≈N/2^{J} | N²L/2^{J-1} |
| Architectures of [16], [17] | $\begin{matrix}4 L or \\ {\sum }_{j = 1}^{J} ⌈ L / {2}^{j - 2} ⌉\end{matrix}$ | N/2 | ≈N²L |
| Architectures | 2L | N | 2N²L |
| in [7], [8], | | | |
| [10]-[12] | | | |
| Architectures | L | 2N | 4N²L |
| in [7], [8] | | | |
| Architectures | JL | N | JN²L |
| in [6], [13] | | | |

However, FPP architectures require a large area for big values of N which makes them impractical for processing long input signals. A more sophisticated architecture is considered in the next section.

### 3.2. Limited Parallel-Pipelined (LPP) Architectures for DWTs

These architectures, which we call limited parallel-pipelined architecture for Haar DWT (or Haar DWT LPP, for short), are obtained from corresponding compact DWT flowgraphs. It should be noted that the compact DWT flowgraph for Haar or for Hadamard wavelets have, in fact, been obtained by decomposition of the computational process for the corresponding 2^{m}-point DWT into a set of 2^{m-J} computational processes each for a 2^{J}-point DWT with a modified appending strategy. The main idea in designing an LPP architecture is to decompose the input 2^{m}-point vector x into a set of 2^{m-j} subvectors x^{(0,s)} or x^{(0,s)},s=0, . . . ,2^{m-J}−1 of length 2^{J} (in a way similar to that used in Section 2.1 or Section 2.2) and process them in the pipelined mode. As can be seen in the previous subsection, the FPP architecture is very efficient in the pipelined mode. However, we cannot directly compute DWTs of the stream of vectors \tilde{x}^{(0,s)},s=0, . . . ,2^{m-j}−1, on the FPP (for a 2^{j}-point DWT) in order to obtain the DWT of the vector x. Some modification to support the modified appending strategy is needed. Several possibilities exist for doing this. Within the LPP architecture presented here, the modified appending strategy is supported by including delays and additional connections between the pipeline stages of the FPP according to the compact DWT flowgraph structure.

Consider an example of the LPP architecture corresponding to the case of Haar wavelet with L=6 and J=3. The architecture in this case (shown in FIG. 8) consists of three pipeline stages each consisting of a block of delays and a block of PEs of the same structure as for the FPP. The eight inputs of the architecture are connected to a group of eight delay elements (delaying for one time unit) of the first pipeline stage. The outputs of the delay elements as well as the first four inputs are connected to the inputs of the PEs of the first stage. Outputs of the delays 2i=0 (i=0) to 2i+L−1=5 are connected to the inputs of the zeroth PE (PE_{1,0}) of the first stage. Outputs of the delays 2i=2 (i=1) to 2i+L−1=7 are connected to the inputs of the first PE (PE_{1,1}). Outputs of the “delays” 2i=4 (i=2) to 2i+L−1=9 are connected to the inputs of the second PE (PE_{1,2}) where, for convenience, we assume the eighths and ninth “zero delay” elements which are, in fact, the zeroth and the first inputs of the first stage. Similarly, outputs of the “delays” 2i=6 (i=3) to 2i+L−1=11 are connected to the inputs of the third PE (PE_{1,3}) of the first stage.

In the case of FIG. 8, a serial/parallel adapter is used in the case of word-serial input. It simply consists of a “serial input/parallel output” shift register (shown as a box on the left side of the Figure).

TABLE 2
Computation process within the LPP architecture (L = 6, J = 3)

| | PE_{1,0} | | PE_{1,1} | | PE_{1,2} | | PE_{1,3} | |
|---|---|---|---|---|---|---|---|---|
| t | input | output | input | output | input | output | input | output |
| 1 | \tilde{x}^{(0,0)} (0:5) = | \tilde{x}⁽¹⁾ (0) = | \tilde{x}^{(0,0)} (2:7) = | \tilde{x}⁽¹⁾ (1) = | [\tilde{x}^{(0,0)} (4:7), | \tilde{x}⁽¹⁾ (2) = | [\tilde{x}^{(0,0)} (6:7), | \tilde{x}⁽¹⁾ (3) = |
| | \tilde{x}⁽⁰⁾ (0:5) | \tilde{x}^{(1,0)} (0), | \tilde{x}⁽⁰⁾ (2:7) | \tilde{x}^{(1,0)} (1), | \tilde{x}^{(0,1)} (0:1)]^{T} = | \tilde{x}^{(1,0)} (2), | \tilde{x}^{(0,1)} (0:3)]^{T} = | \tilde{x}^{(1,0)} (3), |
| | | \tilde{x}⁽¹⁾ (8) = y₈ | | \tilde{x}⁽¹⁾ (9) = y₉ | \tilde{x}⁽⁰⁾ (4:9) | \tilde{x}⁽¹⁾ (10) = y₁₀ | \tilde{x}⁽⁰⁾ (6:11) | \tilde{x}⁽¹⁾ (11) = y₁₁ |
| 2 | \tilde{x}^{(0,1)} (0:5) = | \tilde{x}⁽¹⁾ (4) = | \tilde{x}^{(0,1)} (2:7) = | \tilde{x}⁽¹⁾ (5) = | [\tilde{x}^{(0,1)} (4:7), | \tilde{x}⁽¹⁾ (6) = | [\tilde{x}^{(0,1)} (6:7), | \tilde{x}⁽¹⁾ (7) = |
| | \tilde{x}⁽⁰⁾ (8:13) | \tilde{x}^{(1,1)} (0), | \tilde{x}⁽⁰⁾ (10:15) | \tilde{x}^{(1,1)} (1), | (0:0)]^{T} = | \tilde{x}^{(1,1)} (2), | 0,0,0,0]^{T} = | \tilde{x}^{(1,1)} (3), |
| | | \tilde{x}⁽¹⁾ (12) = y₁₂ | | \tilde{x}⁽¹⁾ (13) = y₁₃ | [\tilde{x}⁽⁰⁾ (12:15), 0,0]^{T} | \tilde{x}⁽¹⁾ (14) = y₁₄ | [\tilde{x}⁽⁰⁾ (14:15), 0,0,0,0]^{T} | \tilde{x}⁽¹⁾ (15) = y₁₅ |

| | PE_{2,0} | | PE_{2,1} | | PE_{3,0} | |
|---|---|---|---|---|---|---|
| t | input | output | input | output | input | Output |
| 3 | [\tilde{x}^{(1,0)} (0:3), | \tilde{x}⁽²⁾ (0) = | [\tilde{x}^{(1,0)} (2:3), | \tilde{x}⁽²⁾ (1) = | — | — |
| | \tilde{x}^{(1,1)} (0:1)]^{T} = | \tilde{x}^{(2,0)} (0), | \tilde{x}^{(1,1)} (0:3)]^{T} = | \tilde{x}^{(2,0)} (1), | | |
| | \tilde{x}⁽¹⁾ (0:5) | \tilde{x}⁽²⁾ (4) = y₄ | \tilde{x}⁽¹⁾ (2:7) | \tilde{x}⁽²⁾ (5) = y₅ | | |
| 4 | [\tilde{x}^{(1,1)} (0:3),0,0]^{T} = | \tilde{x}⁽²⁾ (2) = | [\tilde{x}^{(1,1)} (2:3), | \tilde{x}⁽²⁾ (3) = | — | — |
| | [\tilde{x}⁽¹⁾ (4:7),0,0] | \tilde{x}^{(2,1)} (0), | 0,0,0,0]^{T} = | \tilde{x}^{(2,1)} (1), | | |
| | | \tilde{x}⁽²⁾ (6) = y₆ | [\tilde{x}⁽¹⁾ (6:7),0,0,0,0]^{T} | \tilde{x}⁽²⁾ (7) = y₇ | | |
| 5 | — | — | — | — | — | — |
| 6 | — | — | — | — | [\tilde{x}^{(2,0)} (0:1), | \tilde{x}⁽³⁾ (0) = y₀, |
| | | | | | \tilde{x}^{(2,1)} (0:1),0,0]^{T} = | \tilde{x}⁽³⁾ (2) = y₂ |
| | | | | | [\tilde{x}⁽²⁾ (0:3),0,0]^{T} | |
| 7 | — | — | — | — | [\tilde{x}^{(2,1)} (0:1),0,0,0,0]^{T} = | \tilde{x}⁽³⁾ (1) = y₁, |
| | | | | | [\tilde{x}⁽²⁾ (2:3),0,0,0,0]^{T} | \tilde{x}⁽³⁾ (3) = y3 |

The high-pass outputs of the PEs of the first stage form the (2^{J-1}=4)th to (2^{j-1}=7)th outputs of the architecture while their low-pass outputs form the inputs to the second stage and are connected to a group of 2^{J-1}=4 delays. Outputs of the delays and the first four inputs of the second stage are connected to the inputs of the four PEs of the second stage similarly to as for the first pipeline stage. One half of the PE outputs forms the (2^{J-2}=2)th to (2^{j-1}−1=3)th outputs of the architecture and the other half forms the input to the third pipeline stage. This stage consists of two groups of delay elements each consisting of two delay elements, with the zeroth group with the elements delaying for two time units and the first group with the elements delaying for one time unit. Outputs of all four delays as well as the first two inputs to the stage are connected to the inputs of the single PE of the stage. Outputs of this PE_{3,0} form the zeroth and the first outputs of the architecture. Operation of the LPP architecture corresponding to computation of a 16-point Haar DWT with L=6 and J=3. is summarized in Table 2. At the zeroth time unit, the vector \tilde{x}^{(0,0)}=[x₀, . . . ,x₇] enters to the input registers. At the first step the vector \tilde{x}^{(0,1)}=[x₈, . . . ,x₁₅] enters to the input registers so that the components x₀, . . . ,x₇,x₈, . . . ,x₁₁ begin to be processed with the PEs of the first group. Computation then proceeds in a similar way according to Table 2.

In general, when implementing a 2^{m}-point DWT on the LPP architecture, a subvector \tilde{x}^{(0,s)} (for the case of Haar DWTs) or the subvector x^{(0,s)} (for the case of Hadamard DWTs or wavelet packets) is formed on the input of the first pipeline stage every time unit s=0, . . . ,2^{m-J}−1. With a delay s_{J} (the sum of delay layers of pipeline stages), output subvectors are formed with the same rate of one subvector per time unit. Since there 2^{m-J} subvectors in total when implementing (Haar, Hadamard or wavelet packet) DWT of a vector of length N=2^{m} the total delay of the LPP architecture is given by

T_{LPP}=(S_{J}+N/2^{J}−1)τ (8)

The LPP architecture consists of K=2^{J}−1 PEs in the case of the Haar DWTs or K=J2^{J} PEs in the case of Hadamard wavelets and wavelet packets. Substituting these values into (7) and also noting that the Haar DWT requires T(1)=(2^{m}−1)τ, and the Hadamard DWT requires T(1)=J2^{m-1}τ time units to be implemented with one PE we obtain that the efficiency of the LPP architecture is given by:

$${E}_{L P P} = \{ \begin{matrix}\frac{{2}^{m} - 1}{{2}^{m} + ( {s}_{J} - 1 ) ( {2}^{J} - 1 )} 100 \% & for the Haar DWT \\ \frac{{2}^{m - 1}}{{2}^{m} + ( {s}_{J} - 1 ) {2}^{J}} 100 \% & for the Hadamard DWT\end{matrix}$$

This means the efficiency of the LPP is close to 100% for large values of m (2^{m}>>J&2^{m}>>L):

E_{LPP}100%

even when considering computation of the DWT of one sufficiently long vector and computing the efficiency with respect to time delay. It should be noted that in the case where DWTs of a stream of vectors need to be computed, the period between computation of successive DWTs is

T_{LPP}^{p}=τ2^{m-J}.

Table 1 presents comparative performance of the LPP architecture for the Haar DWT with some known architectures demonstrating excellent Area-Time characteristics of the proposed architecture. Among the other useful features of the architecture should be noted are its regularity, ease of control, absence of long (depending on N) connections, and the independence of the architecture on N meaning that DWTs of different length can be computed with the same hardware. Input to the device can be made as word-parallel as well as word-serial.

### 3.2. The Limited Parallel (LP) Architecture for Hadamard Wavelets and Wavelet Packets

This architecture (see FIG. 9 for an example where N=32, L=4) is obtained by vertically mapping the Hadamard DWT flowgraph onto an array of 2^{J} PEs so that the DWT stages are implemented iteratively. Every stage is implemented in 2^{m-J} time units. When implementing the first stage, the current set of 2^{J}+L−2 input samples enters to the inputs of PEs according to the compact flowgraph structure. In order to append L−2 samples to the current subvector of the length 2^{J} delay elements are introduced before the inputs to the PEs. At every time unit PEs compute 2^{J} intermediate results which are written into a shift register of length N−2^{J}. The contents of the shift register is shifted to the left for 2^{J} positions every time unit. After 2^{m-J} time units, when the results of the first DWT stage are ready, multiplexers pass current set of 2^{J}+L−2 intermediate results from the leftmost cells of the shift register onto inputs of the PEs.

The entire computation takes J2^{m-J}+┌(L−2)/2^{J}┐ time units (the overhead delay of ┌(L−2)/2^{J}┐ time units is introduced due to the delay on the inputs to the PEs). It is easy to verify that the architecture operates at approximately 100% of hardware utilization.

It should be noted that although in the specific embodiments described in the foregoing reference is made to a perfect unshuffle operator, in a more general form of the invention in which the input signal is of length r×k^{m} rather than 2^{m} (representing PEs which carry out k filtering operations rather than two filtering operations, and thus having k outputs rather than two outputs), a stride permutation operation is used.

### 4. CONCLUSION

A flowgraph representation of discrete wavelet transforms (Haar wavelets, Hadamard wavelets, and wavelet packet transforms) has been suggested. This representation is a new definition of DWTs. An approach for developing efficient parallel architectures for implementing DWTs has been suggested. Some examples of architectures designed with the proposed approach have been presented demonstrating excellent area-time characteristics. However, the presented architecture are just some examples for illustrating the approach. For example, the invention can be applied to inverse DWTs including inverse Haar wavelets, inverse Hadamard wavelets, and inverse wavelet packets.

1. A microprocessor structure for performing a discrete wavelet transform operation, said discrete wavelet transform operation comprising decomposition of an input signal vector comprising a number of input samples, over a specified number of decomposition levels j, where j is an integer in the range 1 to J, starting from a first decomposition level and progressing to a final decomposition level, said microprocessor structure having a number of processing stages, each of said stages corresponding to a decomposition level j of the discrete wavelet transform and being implemented by a number of basic processing elements, each of said basic processing elements being arranged to receive a set of data samples and having a number of outputs k, each of said basic processing elements being arranged to perform a set of k similar elemental operations of the discrete wavelet transform on said number of data samples and to produce k output values, said microprocessor structure further comprising a number of routing blocks, a routing block being implemented between each of the processing stages j=1 to J and at the input to the first processing stage, said routing blocks implemented between each of the processing stages being arranged to perform an unshuffling operation to assemble output values produced by the basic processing elements in processing stage j−1 into sets of data samples to be supplied to the basic processing elements in processing stage j.

2. A microprocessor structure according to claim 1 wherein the routing blocks implemented between each of the processing stages j=1 to J are arranged to perform a stride permutation operation.

3. A microprocessor structure according to claim 1 wherein k=2 and the routing blocks implemented between each of the processing stages j=1 to J are arranged to perform a perfect unshuffle operation.

4. A microprocessor structure according to claim 1, wherein the microprocessor structure comprises at least one core processing unit, said core processing unit arranged to perform a k^{J}-point discrete wavelet transform operation.
